(19) United States
(12) Patent Application Publication
(10) Pub. No.: US 2010/0188659 A1
(43) Pub. Date: Jul. 29, 2010

(54) IN-SITU DEVICES, SYSTEMS, AND METHODS FOR GAS SPECIES MEASUREMENT

(76) Inventor: Valery Shver, Tucker, GA (US)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(21) Appl. No.: 12/696,483

(22) Filed: Jan. 29, 2010

Related U.S. Application Data
(60) Provisional application No. 61/148,363, filed on Jan. 29, 2009.

(51) Int. Cl. G01N 21/00; G01J 3/42; B23P 11/00

(52) U.S. Cl. 356/300; 29/428; 356/437

(57) ABSTRACT

Disclosed herein are devices, systems, and methods for use in measuring the concentration component gases in a gaseous mixture. An alignment pipe can be used to maintain the alignment of a laser and a laser receiver for use in laser spectroscopy. The pipe is sufficiently rigid to mount and support the laser and receiver. An exhaust sampling port can be located on the trailing edge of the pipe for admitting gas samples into the pipe to be measured while minimizing the amount of particulate matter that enters the sampling area. The pipe can be double-walled and water cooled to maintain a reasonable temperature. Protective housings can be provided to protect the laser and receiver to improve reliability. The protective housings can be liquid cooled and pressurized to further improve reliability.

### CROSS REFERENCE TO RELATED APPLICATIONS

This application claims the benefit, under 35 U.S.C. §119(e), of U.S. Provisional Patent Application No. 61/148,363, filed 29 Jan. 2009, the entire contents and substance of which is incorporated herein by reference in its entirety as if fully set forth below.

### TECHNICAL FIELD

The various embodiments of the present invention relate generally to devices, systems, and methods for conducting continuous gas analysis and, more particularly, to in-situ devices, systems, and methods for determining the concentration of various gas species in the exhaust of a metallurgical furnace using absorption spectroscopy.

### BACKGROUND

Many processes employ measuring devices, systems, and methods for determining the concentration of individual components of a gas mixture. For example, in automotive applications, an oxygen sensor is used to measure the oxygen content of exhaust gases from the engine. The oxygen content in the exhaust gases can be used, for example, to adjust the air-to-fuel ratio in the engine to maximize efficiency and minimize pollutants.

The gases in the exhaust of a metallurgical furnace, such as an electric arc furnace (“EAF”), can similarly be analyzed to monitor various events within the furnace during processing. During decarburization, for example, oxygen content in the exhaust can be monitored to adjust the rate of oxygen lancing in the melt, preventing waste. Excessive water content in the exhaust can be monitored to detect cooling system leaks in the furnace, which, if left unchecked, can cause problems including explosions. It may also be desirable to monitor the levels of various gases that are poisonous or are pollutants (e.g., carbon monoxide, carbon dioxide, and oxides of nitrogen) in the exhaust. Excessive levels of carbon monoxide in the exhaust can violate environmental regulations and, more significantly, can cause explosions.

Analysis of the exhaust gases, if done in real time (or close to real time), can be used to improve efficiency and to detect problems. Conventionally, however, exhaust gases were analyzed using extractive gas analysis. This analysis requires extracting a sample from the exhaust, cooling it, removing moisture and particulate matter, and then analyzing the dry gas product. Extractive analysis minimizes or eliminates the ability to make “on the fly” corrective and/or optimization adjustments on specific process parameters due to the time required to complete the analysis.

In order to provide real-time data on the combustion process, an in-situ measurement technique is required. This can be done with various types of sensors and/or sender/receiver units that measure some or all of the constituents of a gas sample. As mentioned above, an oxygen sensor, commonly found in automotive applications uses a ceramic probe coated in platinum. A reference voltage is passed through the sensor and the change in voltage is measured over time. The reference voltage varies in proportion to the amount of oxygen in a sample at a given time. This can be useful, for example to control the air/fuel ratio in an automobile.

Spectroscopy can also be used to assess the concentration or amount of a given chemical in a sample. Commonly absorption spectroscopy measures the wavelengths and frequencies of an electromagnetic source that are absorbed by a given sample. Generally, this involves a sender, for generating a beam, usually some sort of electromagnetic radiation, and a receiver. The beam is sent through a sample, and changes in its spectrum are measured at the receiver. The spectral analysis of the change in the beam can be used to determine the components of the sample.

One such measurement technique is laser-gas spectroscopy where the sender is a laser and the receiver is a laser receiver. When laser-gas spectroscopy is used to determine the concentration of constituents in gas mixtures that contain particulates, however, accuracy can be negatively affected. The measurements can be affected by the particles in the exhaust absorbing and/or reflecting the laser beam. In other words, the particles intersect the path of the laser beam and can absorb and/or reflect at least a portion of the laser radiation. If the concentration of particles is high and/or the measurement distance (i.e., the path length of the laser) is large, the intensity of the laser can be decreased to the point that no laser radiation arrives at the detector making analysis impossible.

The second challenge for laser off gas analysis in an EAF is the large variation in temperature found in the EAF. The thermal stresses affect the mounting and alignment of the laser and receiver, leading to misalignment. As with interference, if the laser and receiver become sufficiently misaligned, the level of energy from the laser beam received by the receiver becomes too low to enable accurate analysis.

Laser off gas analysis is known in the art. Laser off gas analysis systems typically use laser spectroscopy to analyze the constituents of a gas sample in real time (i.e., readings can currently be taken on the order of 1000 times per second). Laser off gas analysis may be performed by providing a laser source on one side of a gas sample and a laser receiver on the other. Analysis of the spectrum of light received by the receiver reveals those parts of the spectrum that have been absorbed by the sample. The absorption pattern can then be analyzed to determine the composition of the gas in the sample.

Despite advances in laser spectroscopy, current laser receivers require that certain minimum energy levels be maintained at the receiver to provide accurate readings (currently approximately 5% of the original laser signal). This requires that the laser beam be kept in relatively close alignment with the receiver. In addition, in gas samples with high levels of suspended particles, the particles tend to absorb and diffract the laser beam along the beam path. Lack of protection along the beam path, therefore, can result in beam interference and insufficient energy levels at the receiver.

As shown in FIG. 1a, an exhaust duct 105 is normally used to extract exhaust gases from the EAF 115 during processing. Laser off gas analysis systems 100 are generally mounted in the exhaust duct 105 as close to the melt as is practical. Due to the extreme temperatures in the EAF, consideration must be given to the mounting location of the laser off gas analysis system 100. The laser off gas analysis system 100 must be far enough away from the melt to prevent failure of the system 100. On the other hand, the laser off gas analysis system 100 must be close enough to the melt to provide accurate data.

The duct 105 and the EAF 115 are generally slightly separated creating a combustion gap 110. The combustion gap 110 enables the EAF 115 to tilt during, for example, deslagging or pouring operations. The combustion gap 110 also enables small amounts of outside air to be drawn into the duct 105, which can lower exhaust temperatures. The combustion gap 110 can also provide oxygen from the outside air to convert any free carbon monoxide (CO) in the exhaust flow into carbon dioxide (CO₂), a less toxic, less volatile compound. Care should be taken, therefore, to place the laser off gas analysis system 100 in the exhaust flow of the duct 105, but away from the fresh air being admitted by the combustion gap 110, which can affect readings.

As shown in FIGS. 1b and 1c, the exhaust duct 105 generally comprises a double-walled construction. The duct 105 can comprise an outer duct 107, which is generally constructed of sheet steel formed around an inner duct 109. The inner duct 109 can be formed from steel plates. In addition, the inner duct 109 may be externally cooled by spray bars 111 located inside the outer duct 107 and positioned to spray on the outside of the inner duct 109. The spray bars 111 mist water onto the inner duct 109 to lower its temperature by evaporative cooling.

Conventional laser off gas analysis systems 100 can comprise a laser portion 115 and a receiver portion 120 housed in separate cases 117, 122. The laser portion 115 can contain a laser 125 and one or more servo motors 135. Similarly, the receiver portion 120 can contain the laser receiver 130 and one or more servo motors 135. Consequently, the cases 117, 122 and the two portions of the system 115, 120 are independently mounted on the outside of the duct 105.

Due to the extreme conditions found in an EAF, the exhaust duct 105 experiences considerable expansion and contraction, or “breathing.” For example, the exhaust duct 105 can go from room temperature, when the EAF is inoperative, to over 2500° F. when the EAF is in use. In addition, turbulence caused by the exhaust flow through the duct 105 can cause the duct to move and vibrate considerably.

The movement of the duct 105 tends to cause the laser 115 and the receiver 120 to become misaligned. This misalignment reduces the amount of energy from the laser 115 that is received by the receiver 120. As mentioned above, if the amount of energy received at the receiver 120 is too low, accurate readings are not possible.

Conventionally, highly accurate servo motors 135 have been used to maintain alignment of the laser 115 and receiver 120 despite the movement of the duct 105. This requires that the servo motors 135 be placed in a closed-loop feedback system with the receiver 120 to make constant adjustments to the angle of the laser 115 and/or receiver 120. The servo motors 135 can adjust the angle of the laser 115 and/or receiver 120 based on the strength of the signal at the receiver 120 to compensate for the independent movement of the components on the duct 105.

The feedback system may include a microprocessor, various sensors, and several servo motors 135, which increases the complexity and reduces the reliability of the system. The harsh environment and high temperatures in and around the EAF can lead to electronic and mechanical failures in the feedback and adjustment system. Failure of the servo motors 135 or the feedback system can render the entire system 100 inoperable because it is not possible to maintain the alignment of the laser 115 and the receiver 120.

In addition, because the area 140 between the laser 115 and the receiver 120 is unshielded, the path of the laser 115 can become obscured with particles in the exhaust flow. For example, when the EAF is charged with scrap initially, the electrodes and all burners in the furnace may be activated to heat the charge quickly. During this process, contaminants, such as rust, paint, oil, and dirt, for example, may be present in the charge. During the initial heating phase, these contaminants burn off creating high levels of particulates in the EAF exhaust. Other phases of production, such as carbon lancing, may also cause high levels of particles in the exhaust.

Each particle that crosses the path between the laser 115 and the receiver 120 can block and/or diffract the beam from the laser 115, reducing its intensity. As mentioned, about 5% of the energy from the laser 115 must reach the receiver 120 to maintain accurate readings. If the level of particulates in the exhaust is high enough, however, the amount of laser energy reaching the receiver 120 can be reduced to the point that accurate readings are not possible. The conventional system 100, therefore, suffers from both alignment issues, due to the mounting arrangement, and interference issues, due to the open sample area 140. What is needed is a system that provides a robust and trouble-free solution to this ubiquitous problem. It is to such a system the embodiments of the present invention are primarily directed.

### BRIEF SUMMARY

Embodiments of the present invention relate to an apparatus, system, and method for mounting an off gas analysis system for use in the analysis of various exhaust gases. In particular, embodiments of the present invention relate to an apparatus, system, and method for mounting a laser off gas analysis system on the exhaust duct of a metallurgical furnace. Embodiments of the present invention can comprise a pipe for supporting and aligning the laser and laser receiver of a laser off gas analysis system.

In some embodiments, the pipe can comprise a slot, or exhaust gas sampling port, configured to minimize particle buildup in the sampling area of the pipe. The laser creates a laser beam that penetrates a flow, such as in an exhaust pipe or duct. The laser beam is then received at the laser receiver and analyzed. The characteristics of the light received can be correlated to the gas species found in the exhaust.

Embodiments of the present invention can comprise a mounting system for an off gas analysis system. The off gas analysis system itself can comprise a sender and a receiver. In some embodiments, the sender can comprise a laser, though other types of electromagnetic beams are contemplated. The mounting system can comprise an outer pipe with a first end and a second end and an inner pipe, with a first end and a second end. The first pipe can be disposed coaxially within the outer pipe. The system can further comprise a first gas fitting disposed on the first end of the outer pipe and in fluid communication with the inner pipe. The system can also comprise a first coolant fitting disposed on the first end of the outer pipe and in fluid communication with the outer pipe.

The outer pipe can comprise a first exhaust sampling port, disposed in the middle of the outer pipe and in fluid communication with the inner pipe. The first exhaust sampling port can admit an exhaust gas sample into a sampling area disposed in the middle of the inner pipe. The sender from the off gas analysis system can be mounted on the first end of the inner pipe, the outer pipe, or both. Similarly, the receiver from the off gas analysis system can be mounted on the second end of the inner pipe, the outer pipe, or both. The inner pipe and/or the outer pipe can maintain the alignment of the sender and the receiver to ensure accurate readings.

In some embodiments, the outer pipe and the inner pipe can form a water jacket. The system can further comprise a first coolant fitting is in fluid communication with the water jacket used to cool the inner and outer pipe. In some embodiments, there can be a second coolant fitting disposed on the second end of the outer pipe and in fluid communication with the water jacket. In this configuration, coolant can enter the water jacket through the first coolant fitting and exit the water jacket through the second water fitting, providing flow-through cooling.

In some embodiments, the first gas fitting can provide an inert gas to the first end of the inner pipe. The inert gas can be used to purge the first end of the inner pipe of exhaust gases to prevent inaccurate readings. In some embodiments, the system can further comprise a second gas fitting disposed on the second end of the outer pipe and in fluid communication with the second end of the inner pipe. The second gas fitting similarly provides inert gas to the second end of the inner pipe to purge the second end of the inner pipe of exhaust gases. In this manner, “old” exhaust gases can be constantly cleared from the sides of the inner pipe.

In some embodiments, the first exhaust sampling port can be located on a trailing edge of the outer pipe. The location of the exhaust sampling port can prevent the accumulation of particulate matter in the inner pipe. In some embodiments, the system can further comprise a second exhaust sampling port. The second exhaust sampling port can be disposed on the leading edge or the trailing edge of the outer pipe, depending on the intended use (i.e., the typical level of particulates in the flow). In some embodiments, the outer pipe can further comprise an airfoil, disposed on the leading edge of the outer pipe. The airfoil can direct particles in the exhaust flow around the outer pipe to prevent buildup.

In some embodiments, the system can further comprise a first protective housing disposed proximate the first end or the second end of the outer pipe. The protective housing can be positively pressurized with an inert gas to minimize contaminant infiltration into the protective housing.

In some embodiments, the system can further comprise a laser, coupled to the first end of the inner pipe, the outer pipe, or both. The laser can be used to generate a laser beam through the exhaust flow. The system can further comprise a laser receiver, coupled to the second end of the of the inner pipe, the outer pipe, or both. The receiver can receive the energy from the laser after it has passed through the exhaust flow for analysis. The system can comprise protective housings for protecting the laser and the receiver from the harsh environment near the EAF.

Embodiments of the present invention can also comprise a method for installing an off gas analysis system on the exhaust duct of a metallurgical furnace. The system can be installed by inserting an alignment pipe, comprising a first end and a second end, through holes in the exhaust duct. The holes may be preexisting, from a previous installation, or may be created at the time of installation. A sender can be detachably coupled to the first end of the alignment pipe, and a receiver can be detachably coupled to the second end of the alignment pipe. Protective housings can be detachably coupled to both ends of the alignment pipe to enclose the sender and the receiver. The alignment pipe can comprise an exhaust sampling port, disposed in the middle of the pipe, for sampling exhaust gases.

In some embodiments, the method can further comprise attaching a coolant supply and coolant return to the alignment pipe to enable flow through cooling. In other embodiments, the method can also comprise attaching an inert gas to both ends of the inner pipe to purge it. In some embodiments, it may be desirable to install a packing material around the outer pipe to seal it where it goes through the duct. Mounting collars can be installed on the exhaust duct near the holes to reinforce the holes and/or seal around the alignment pipe. In some embodiments, the method can further comprise attaching coolant and inert gas supplies to the protective housings for the system.

To the accomplishment of the foregoing and related ends, the following description and annexed drawings set forth in detail certain illustrative aspects and implementations of the invention. These are indicative of but a few of the various ways in which the principles of the invention may be employed. Other aspects, advantages, and novel features of embodiments of the invention will become apparent from the following detailed description of the invention when considered in conjunction with the drawings.

### BRIEF DESCRIPTION OF THE DRAWINGS

FIG. 1a depicts a side view of a conventional laser off gas analysis system installed in an exhaust duct on an electric arc furnace (“EAF”).

FIG. 1b depicts a perspective view of the conventional laser off gas analysis system of FIG. 1a.

FIG. 1c depicts a cross-sectional view of the conventional laser off gas analysis system of FIG. 1a.

FIG. 2a depicts a front, cross-sectional view of an off gas analysis system, in accordance with some embodiments of the present invention.

FIG. 2b depicts a rear, cross-sectional view of the off gas analysis system of FIG. 2a, in accordance with some embodiments of the present invention.

FIG. 3a depicts a detailed view of a mounting system for the off gas analysis system of FIG. 2a, in accordance with some embodiments of the present invention.

FIG. 3b depicts a detailed view of the mounting system of claim 3a with a two-piece collar, in accordance with some embodiments of the present invention.

FIG. 4a depicts a rear view of the off gas analysis mounting system, in accordance with some embodiments of the present invention.

FIG. 4b depicts a cross-sectional view of a sampling area of the laser off gas analysis mounting system of FIG. 4a, in accordance with some embodiments of the present invention.

FIG. 4c depicts a cross-sectional view of a water jacket and various fittings on the laser off gas analysis mounting system of FIG. 4a, in accordance with some embodiments of the present invention.

FIG. 5 depicts a cross-sectional view of the laser off gas analysis mounting system of FIG. 4a fitted with an airfoil, in accordance with some embodiments of the present invention.

FIGS. 6a and 6b depict an embodiment of the laser off gas analysis mounting system with direct gas ports, in accordance with some embodiments of the present invention.

### DETAILED DESCRIPTION

Embodiments of the present invention are directed to a mounting system for a laser or other type of off gas measurement system. The system can be installed in a variety of applications in which gas analysis is affected by, for example and not limitation, high temperatures, high levels of vibration or movement, or high levels of particulates in the gas to be measured. In some embodiments the system can comprise a water-cooled alignment pipe with one or more gas sampling ports. The gas sampling ports can be arranged to minimize both the level of particles in the path of the laser and the build up of particles in the gas sampling area. The system can provide real time gas analysis in a variety of hostile environments, including but not limited to metallurgical furnaces.

Embodiments of the present invention are described below as a laser off gas measurement system for use in metallurgical furnaces (e.g. electric arc furnaces or EAFs) with double-walled sheet metal exhaust ducts. The description is so limited to provide a clear and brief description of the invention and not to limit the invention in any way. Embodiments of the invention can, for example, be used in EAFs with exhaust ducts formed from cooling pipes rather than sheet metal. Embodiments of the present invention are also not limited to use in metallurgical furnaces, but rather may be used in any location where gas analysis is desirable.

Embodiments of the present invention are also described for use with a laser off gas measurement systems. Those skilled in the art will recognize, however, that other suitable sender/receiver combinations exist and are intended to be encompassed herein. Embodiments of the present invention enable gas analysis to be performed in locations where analysis is hampered by vibration, high heat, and/or high levels of particles in the flow. Embodiments of the present invention can be used, for example and not limitation, for analysis of exhaust gases from internal and external combustion engines.

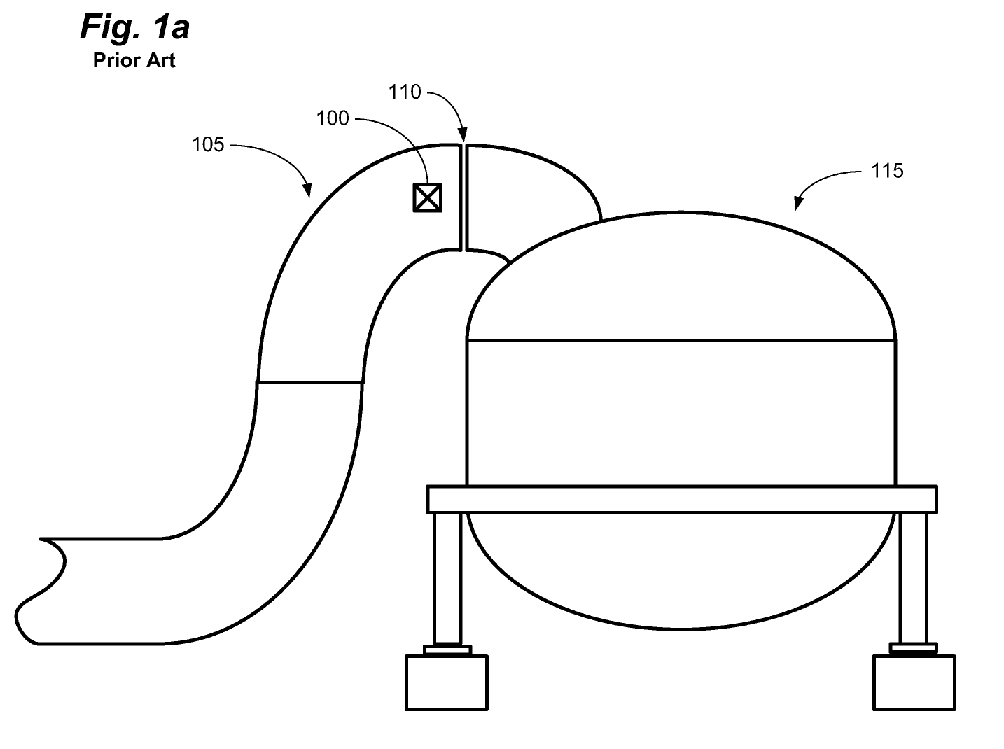

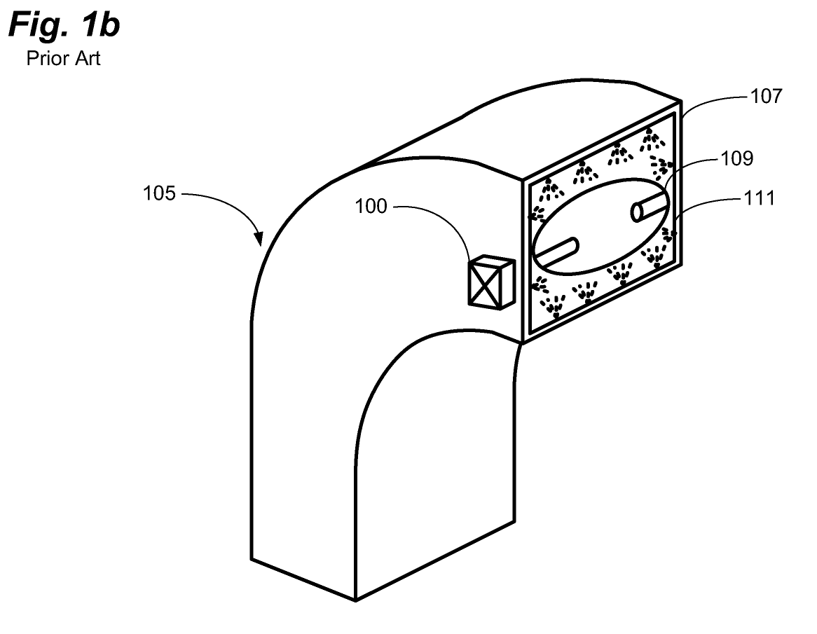

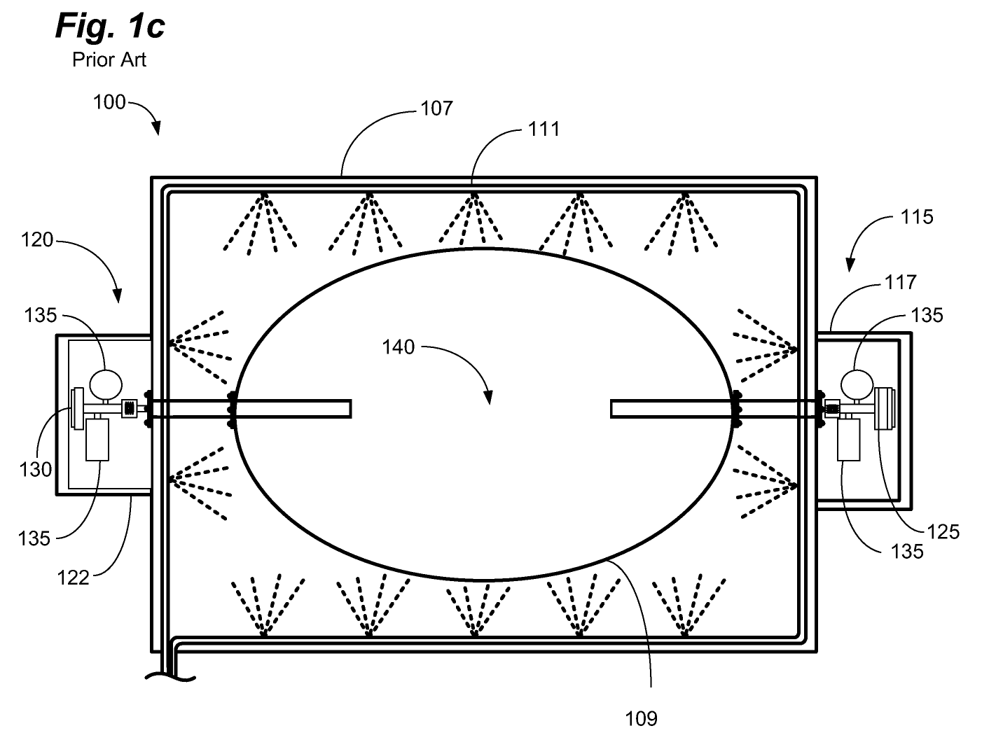

Embodiments of the present invention can be installed in place of, or retrofitted to, existing conventional systems 100. Referring back to FIG. 1a, the system should be installed as close as is feasible to the EAF 115 to obtain accurate and timely readings. On the other hand, the system must be installed a sufficient distance away from the combustion gap 110, or any other areas where outside air is mixed with exhaust gases on the duct 105, to prevent errant “false air” readings. Provided the conventional system 100 was installed in an appropriate location, the system may be installed as a retrofit, with minimal modification. If, on the other hand, the conventional system 100 was improperly installed or located, significant reworking can be required.

Referring now to the figures, wherein like reference numerals represent like parts throughout the several views, exemplary embodiments of the present invention will be described in detail. Throughout this description, various components may be identified having specific values or parameters, however, these items are provided as exemplary embodiments. Indeed, the exemplary embodiments do not limit the various aspects and concepts of the present invention as many comparable parameters, sizes, ranges, and/or values may be implemented.

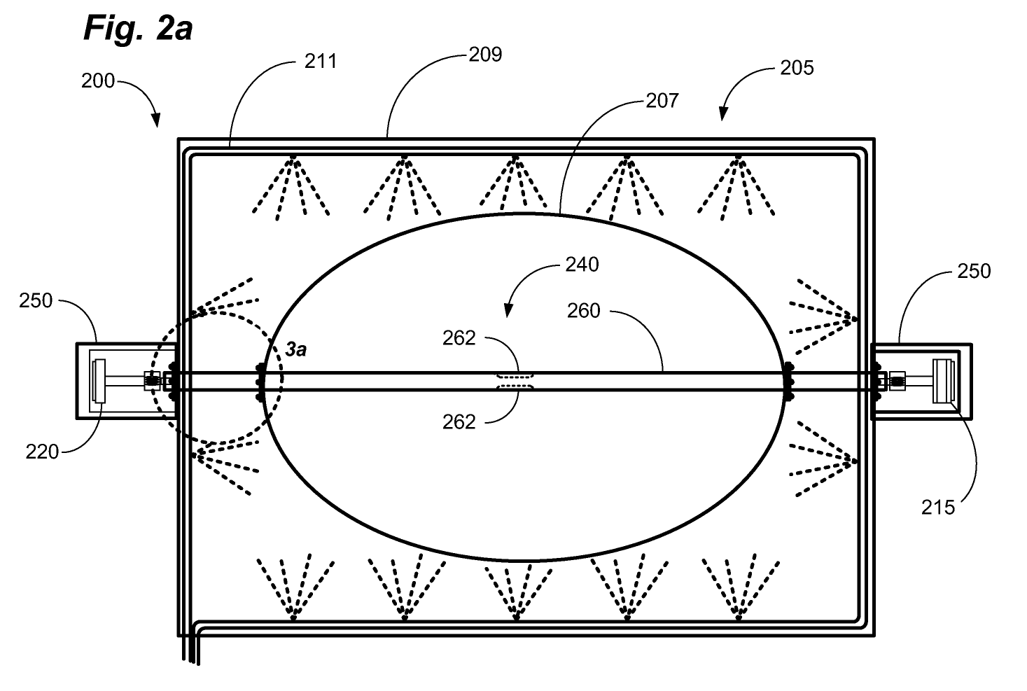

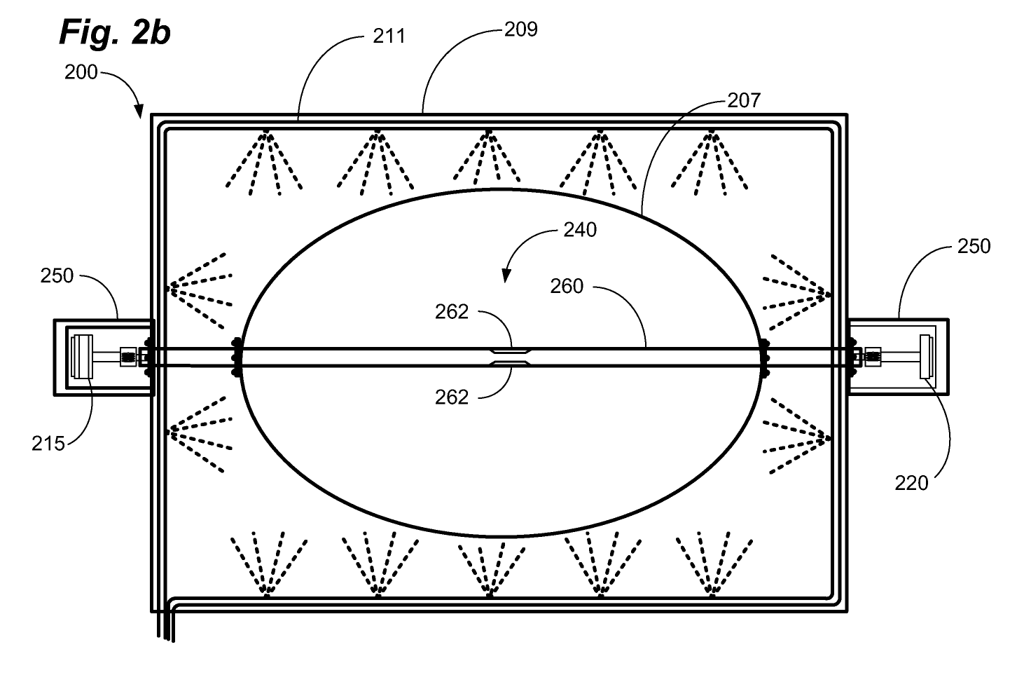

As shown in FIG. 2a, viewed from the upstream or EAF side, and 2b, viewed from the downstream side, embodiments of the present invention can comprise a sender 215 and a receiver 220. The sender 215 can generate a concentrated beam of electromagnetic energy. The sender 215 can be, for example and not limitation, an x-ray, electron, photon, radio, or microwave source. In a preferred embodiment, the sender 215 can be a laser 215 and the receiver 220 can be a laser receiver 220. The laser 215 and receiver 220 can be coupled by an alignment pipe 260 (“pipe”). The pipe 260 can comprise one or more exhaust sampling ports 262 to collect gas samples from the exhaust flow. The pipe 260 can maintain the alignment of the laser 215 and the receiver 220 by coupling them together in a substantially rigid fashion. This eliminates the need for servo motors 130, sensors, and a feedback system, greatly simplifying the system 200 and increasing its reliability.

To further increase reliability, the laser 215, receiver 220, and other necessary electronic components, can be housed in protective housings 250. The protective housings 250 can be mounted on the duct 205 and can be substantially sealed from the surrounding environment. Slightly pressurized nitrogen, or other inert gas, can be fed into the housings 250 to provide an inert and slightly pressurized interior. This slight overpressure prevents particles and debris from entering the housings 250 and provides a clean, inert environment for the electronics, increasing reliability. The inert gas may also provide a cooling effect inside the housings 250 as a beneficial side effect.

In some embodiments, the housings 250 can be actively cooled. The housings 250 can, for example, include passages or pipes to enable the housings 250 to be cooled with air or water. In some embodiments, the housings 250 can be cooled using water from an existing misting system 211 used to cool the inner duct 207. In other embodiments, the housings 250 may be cooled using water from existing cooling systems on the EAF. In still other embodiments, the housings 250 may be cooled using a standalone cooling system using, for example and not limitation, air, water, or liquid nitrogen.

Rather than being mounted to the housings 250 and/or the duct 205, however, the laser 215 and receiver 220 can be mounted to the pipe 260. The pipe 260 can be sufficiently rigid to support the weight of the laser 215 and the receiver 220 across the span between the walls of the inner duct 207. The pipe 260, therefore, can maintain the laser 215 and receiver 220 in sufficient alignment despite distortion, expansion, contraction, or movement in the duct 205. In other words, the movement of the duct 205 may cause the system 200 to move as a unit, but the position of the laser 215 and the receiver 220 relative to each other remains substantially the same. In addition, because (as mentioned above) a signal of approximately 5% or greater is sufficient to accurately analyze the melt, any slight misalignment caused by distortion in the pipe 260 due to sag or flex from heat and/or aerodynamic effects is inconsequential.

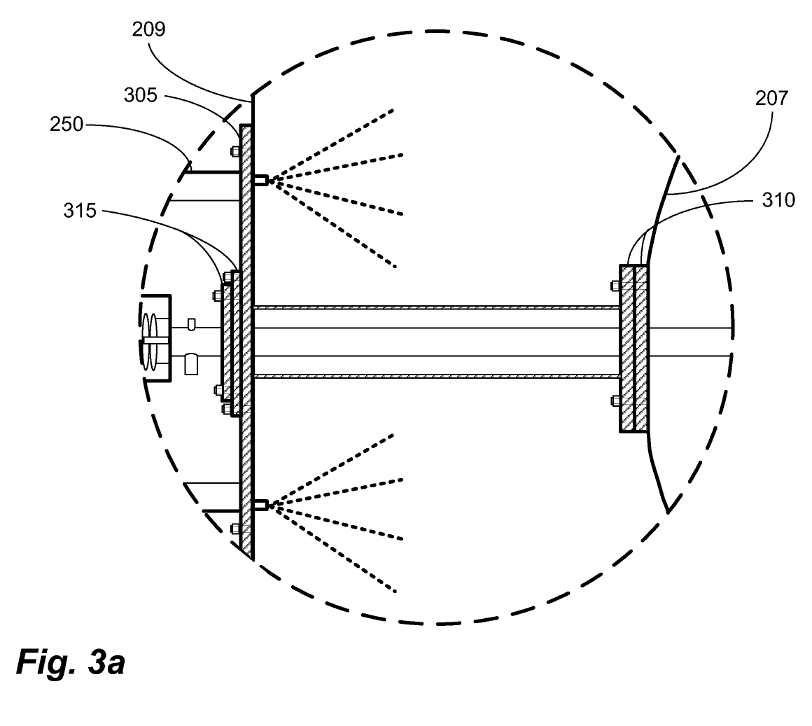

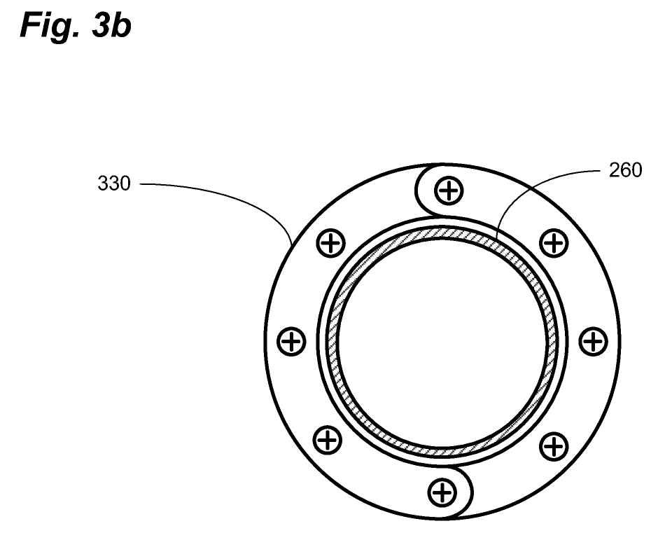

As shown in the detailed FIG. 3a, the system 200 can be mounted on the duct 205 using one or more mounting collars 310, 315. Mounting holes can be cut in the inner duct 207 and the outer duct 209 to enable the pipe 260 to be inserted through the duct 205 on both sides. Due to the size of the various fittings on the pipe 260, it can be necessary to cut holes in the 205 that are larger than the diameter of the pipe 260. In some embodiments, reinforcing collars 310, 315 can be used to bridge the gap between the mounting hole and the pipe 260. The mounting collars 310, 315 can reduce the amount of packing, or other material, needed to seal around the pipe 260 where it passes through the duct 205. Sealing around the pipe 260 can be useful, for example, to contain the heat from the exhaust flow or to water from the misting system 211.

In other embodiments, the reinforcing collars 310, 315 may also be used to reinforce the mounting holes. In still other embodiments, the mounting collars 310, 315 can serve to clamp the pipe 260 rigidly to the duct 205. In a preferred embodiment, however, the pipe 260 can simply be inserted through the collars 310, 315 in a floating arrangement. In this manner, the pipe 260 is free to move relative to the duct 205, while still maintaining the alignment of the laser 215 and the receiver 220. In some embodiments, it may be desirable to insert soft refractory packing material between the pipe 260 and the collars 310, 315 to minimize exhaust, heat, and water infiltration into the outer duct 207 and housings 250.

In some embodiments, the housings 250 can be mounted directly to the outside 309 of the duct 205. In other embodiments, such as when increased rigidity is required, the housings 250 can be mounted to the duct using a mounting plate 305. In still other embodiments, the housings 250 can be mounted directly to the pipe 260. This can enable the system 200 to be mounted independently from the duct 205 except where the pipe 260 rests on the duct 205. In some embodiments, the pipe 260 may be supported on resilient mounts to minimize vibration transfer between the duct 205 and the pipe 260. If complete isolation is desired, the system 200 can be mounted on separate mounting stands (not shown).

As shown in FIG. 3b, in some embodiments, two piece collars 330 can be used to mount the system 200 to the duct 205. This can ease installation by allowing the collars 330 to be slipped over the pipe 260 after it is inserted in the duct 205 and can make repairs easier to affect during use. Using one piece collars 310, 315 can provide additional strength, but requires positioning the collar(s) 410, 415 before inserting the pipe 260 in the duct 205 increasing the difficulty of installation. Two-piece collars 330 can also enable the system 200 to be partially pre-assembled, easing installation.

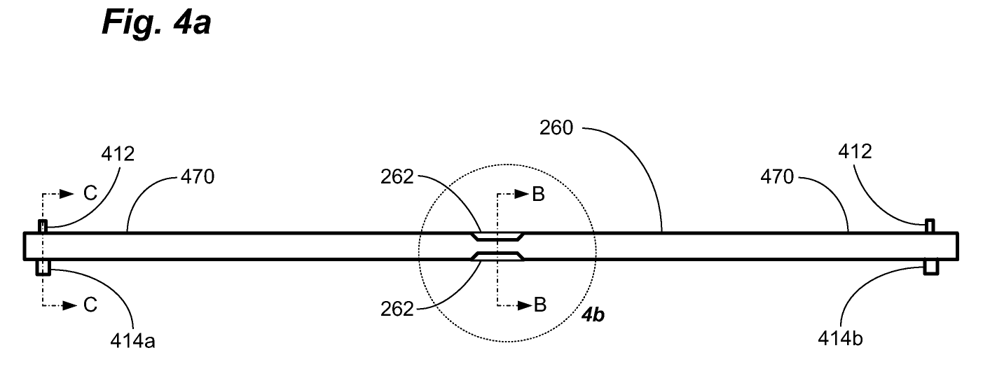

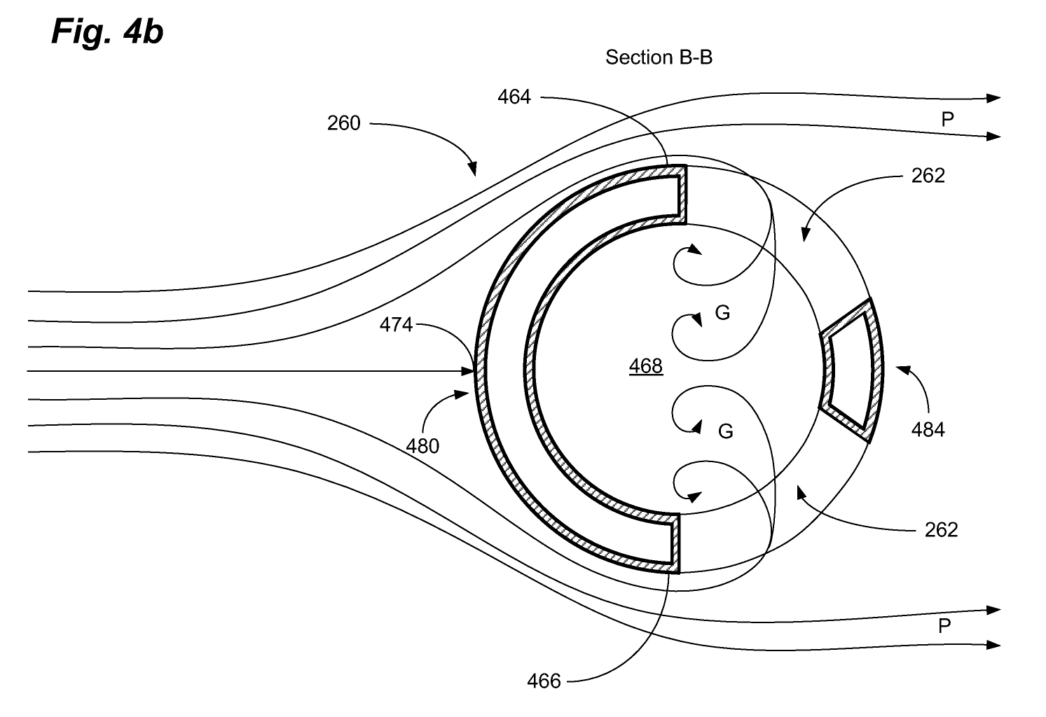

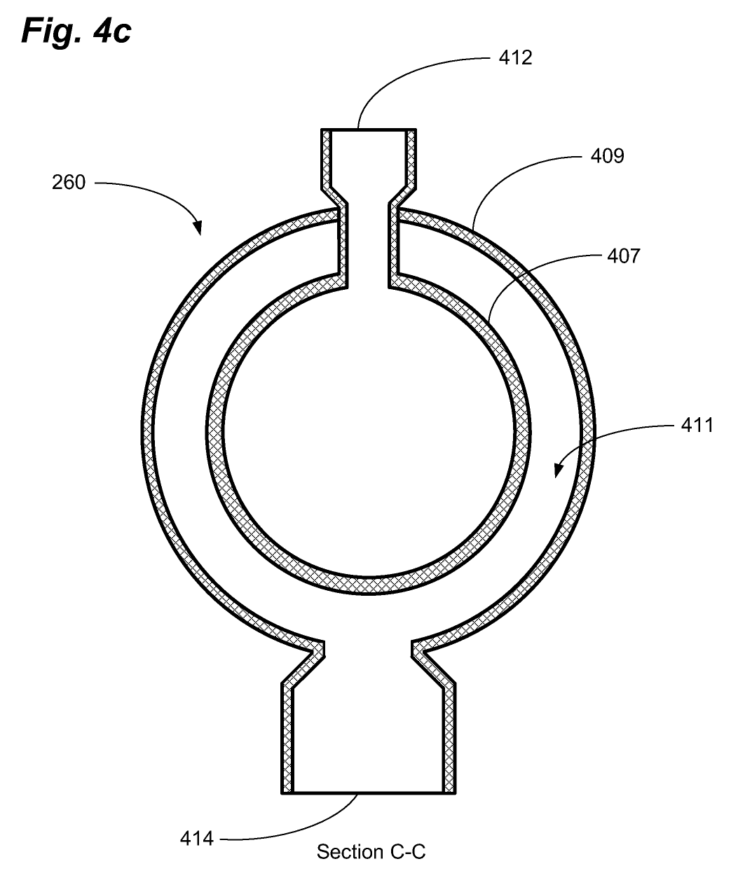

As shown in FIGS. 4a and 4b, the pipe 260 can further comprise one or more exhaust sampling ports 262. In some embodiments, the exhaust sampling ports 262 can be disposed substantially in the center of the pipe 260 lengthwise. In this manner, the exhaust sampling ports 262 can be centered in the exhaust flow. The exhaust sampling ports 262 can be disposed on the pipe 260 such that they are on the trailing edge 485 of the pipe 260. In other words, the exhaust sampling ports 262 can be disposed on the pipe 260 on the trailing, or downstream, side 485 of the exhaust flow.

In this configuration, exhaust gas can flow over the top edge 464 and bottom edge 466 of the pipe 260, creating an area of low pressure on the downstream side 485 of the pipe 260. As a result, the gases G of the exhaust flow tend to swirl inwardly and enter the sampling area 468. Particles P in the flow, on the other hand, will tend to continue past the sampling area 468 due to their higher mass and momentum. This tends to prevent the buildup of particulate matter in the sampling area 468.

Reducing the amount of particulate matter entering the sampling area 468 has several benefits. The most obvious benefit is that the less particulate matter that enters the sampling area 468, the less particulate matter can accumulate there. This reduces maintenance and increases the time between cleanings. In addition, less particulate matter in the sampling area 468 reduces the problems associated with particle interference with the laser 215 beam path, mentioned above. This reduced interference results in a stronger and more accurate laser 215 signal at the receiver 220, which results in more accurate and consistent readings by the system 200.

As shown in FIGS. 4a-4c, the pipe 260 can have a double-walled construction comprising an inner pipe 407 and an outer pipe 409. In some embodiments, one or both ends of the pipe 260 can be fitted with one or more gas fittings 412 and one or more coolant fittings 414.

The double-walled construction of the pipe 260 can enable the pipe 260 to be cooled using a suitable coolant. In some embodiments, the inner 407 and outer 409 pipes can form a water jacket 411 to enable water, or other coolant, to be passed through the pipe 260 to cool it. In some embodiments, the pipe 260 can be cooled using other suitable means, such as for example and not limitation, ethylene glycol, alcohol, or liquid nitrogen. In some embodiments, coolant can enter the water jacket 411 via a first, supply fitting 414a, and exit the water jacket through a second, outlet fitting 414b. In this manner, coolant can enter one end of the pipe 260 and exit the other, though other configurations are contemplated. Cooling the pipe 260 can increase the life of the pipe 260 and other system components, minimize pipe 260 sag, and reduce heat transfer from the pipe 260 to the housings 250 and other components therein. See, FIG. 2a.

Because exhaust gases enter the sampling area 468 in a relatively passive way, e.g., they are not drawn or forced into the sample area; a means is required to prevent the accumulation of exhaust gases in the pipe 260. In some embodiments, therefore, the pipe 260 can further comprise one or more gas fittings 412a, 412b. The gas fittings 412a, 412b can be used to supply each end 470 of the pipe 260 with a test gas at relatively low pressure of, for example and not limitation, between 0.5 and 5 psi. The test gas serves to keep the pipe 260 outside the sampling area 468 purged. In other words, the gas is provided to each end 470 of the pipe 260 at a low pressure and then travels toward the middle of the pipe 260 and out the edges of the exhaust sampling port 262. This process occurs naturally as the test gas is introduced under pressure and then seeks pressure equilibrium with the surrounding flow.

In this configuration, the test gas serves to constantly push exhaust gases out of the sides 470 of the pipe 260. Exhaust gases, thus, are prevented from accumulating in the sides 470 of the pipe 260, i.e., in the areas 470 outside the sampling area 468, and adversely affecting readings. In some embodiments, the test gas can be, for example and not limitation, nitrogen or argon. The presence of the test gas in the pipe 260 can be accounted for and removed from the spectral analysis, leaving only the analysis of the exhaust gas in the sampling area 468. The test gas also ensures that the exhaust gas being sampled is a newly acquired, or “fresh,” sample by preventing accumulation in the pipe 260.

As shown in FIG. 4b, the area in the center of the leading edge 480 of the pipe 260 is an aerodynamic stagnation point 475. In other words, a boundary layer forms on the surface of the pipe 260 to redirect the exhaust flow as it approaches the pipe. As a result, the exhaust flow is redirected by the boundary layer to bend around either side of the pipe 260. Near the center 474 of the pipe 260, however, the flow directly impinges on the boundary layer. As the flow approaches the pipe 260 it can go straight through the boundary layer causing particles to stick to the leading edge 480 of the pipe 260.

Over time, the flow impinging on the pipe 260 can cause a buildup of particulate matter on and around the stagnation point 475 on the leading edge 480 necessitating periodic cleaning of the pipe 260. To reduce or minimize this accumulation, therefore, in some embodiments, the pipe 260 can be coated with a low friction coating. The coating can be, for example and not limitation, chrome, PTFE, or Electroless nickel plating.

In other embodiments, the pipe 260 can be coated in a refractory material or coating. The refractory material can be used to provide thermal protection in addition to, or instead of, the internal cooling discussed above. The refractory material can be, for example and not limitation, oxides of aluminum, silicon, calcium, or magnesium, or fireclays. In some embodiments, the pipe 260 can be coated in a refractory material and then coated in a low friction coating to achieve the benefits of both coatings.

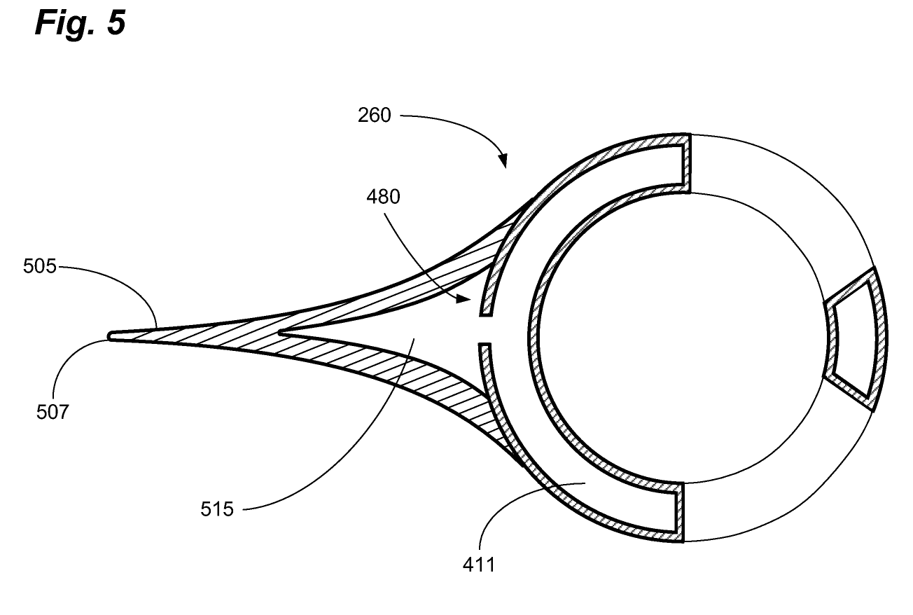

As shown in FIG. 5, in still other embodiments, the pipe 260 can further comprise an airfoil 505. The airfoil 505 can direct the exhaust flow around the leading edge 480 of the pipe 260. Due to its relatively small frontal area, accumulation on the leading edge 507 of the airfoil 505 is minimized. In some embodiments, the airfoil 505 can be symmetrical and can be configured to provide zero lift. In this configuration, the airfoil 505 can redirect particles around the pipe 260 to prevent accumulation thereon. In other embodiments, the airfoil 505 can be asymmetrical, or can be mounted at a non-zero angle of attack relative to the exhaust flow. In this configuration, the airfoil 505 can create a slight lifting force to counteract any sag in the pipe 260 due to heat or weight considerations.

In some embodiments, the airfoil 505 can comprise one or more coolant passages 515. A suitable coolant can be passed through the coolant passages 515 to maintain the airfoil 505 at a suitable temperature. In some embodiments, the coolant passage 515 can be plumbed directly into the water jacket 411 of the pipe 260. In some embodiments, the coolant passages 515 may be separately plumbed or tied into the cooling system for the EAF.

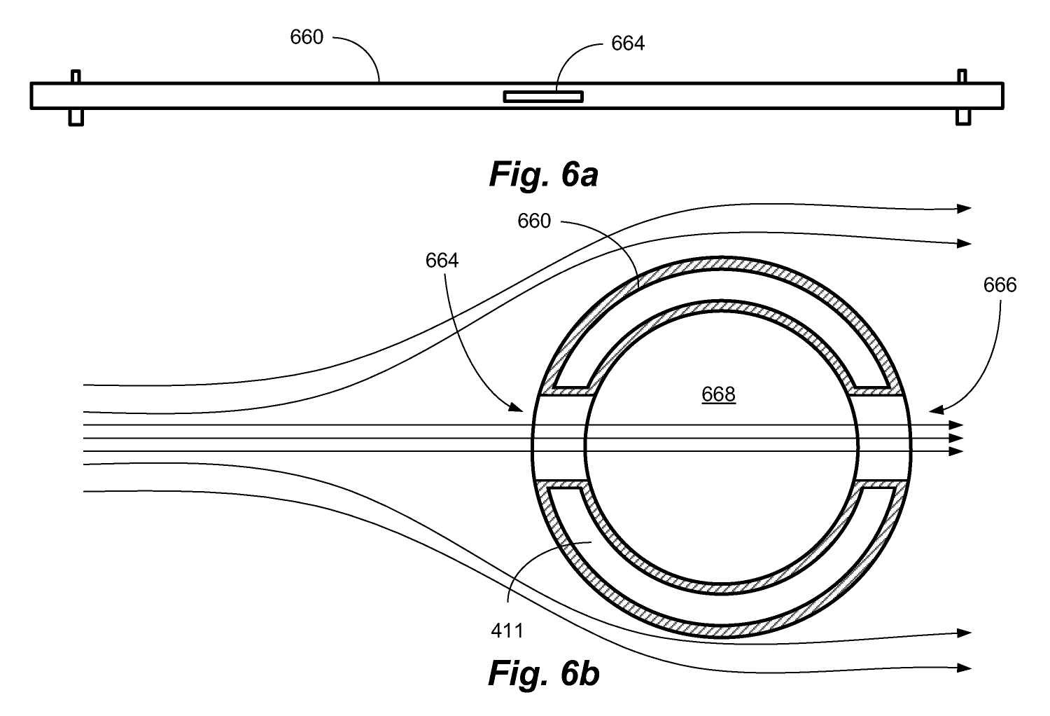

In some embodiments, as shown in FIGS. 6a and 6b, it may be possible to have a direct exhaust sampling port 664. For example, in applications where the exhaust flow is relatively free from particulates, it may be unnecessary to provide an indirect path to the gas port. If the exhaust flow is relatively clean, the likelihood of buildup on the pipe 660 and in the sample area 668 is reduced. In some embodiments, therefore, the exhaust flow can flow directly into the pipe 660 via a front exhaust sampling port 664 and exit the pipe 660 via a rear exhaust sampling port 666. This can provide a slightly more direct measurement of the exhaust gases, but as mentioned, requires a relatively clean flow.

While the various embodiments of this invention have been described in detail with particular reference to exemplary embodiments, those skilled in the art will understand that variations and modifications can be effected within the scope of the invention as defined in the appended claims. For example, while several different configurations have been disclosed for gas ports, the invention can also be practiced using fewer or more gas ports, or gas ports in different configurations. In addition, the system is disclosed for use with a laser and laser receiver, but other types of sender/receiver units could be utilized. The system is also disclosed for use in an EAF, but could, for example and not limitation, be used in automotive applications in place of an exhaust oxygen sensor, or could be used in industrial smoke stacks to monitor smokestack emissions.

Accordingly, the scope of the various embodiments of the present invention should not be limited to the above discussed embodiments, and should only be defined by the following claims and all applicable equivalents.

What is claimed is:

1. A mounting system for an off gas analysis system comprising a sender and a receiver, the mounting system comprising:
an outer pipe with a first end and a second end;
an inner pipe, with a first end and a second end, disposed coaxially within the outer pipe;
a first gas fitting disposed on the first end of the outer pipe and in fluid communication with the inner pipe;
a first coolant fitting disposed on the first end of the outer pipe and in fluid communication with the outer pipe; and
a first exhaust sampling port, disposed in the middle of the outer pipe and in fluid communication with the inner pipe, for admitting an exhaust gas sample into a sampling area disposed in the middle of the inner pipe;
wherein a sender is mounted on the first end of the inner pipe, the outer pipe, or both;
wherein a receiver is mounted on the second end of the inner pipe, the outer pipe, or both; and
wherein the inner pipe and the outer pipe substantially maintain the alignment of the sender and the receiver.

2. The mounting system of claim 1, wherein the outer pipe and the inner pipe form a water jacket therebetween; and
the first coolant fitting is in fluid communication with the water jacket to provide coolant to cool the inner and outer pipe.

3. The mounting system of claim 2, further comprising:
a second coolant fitting disposed on the second end of the outer pipe and in fluid communication with the water jacket;
wherein the coolant enters the water jacket through the first coolant fitting and exits the water jacket through the second water fitting to provide flow-through cooling.

4. The mounting system of claim 1, wherein the first gas fitting provides an inert gas to the first end of the inner pipe to purge the first end of the inner pipe of exhaust gases.

5. The mounting system of claim 1, further comprising:
a second gas fitting disposed on the second end of the outer pipe and in fluid communication with the inner pipe;
wherein the second gas fitting provides an inert gas to the second end of the inner pipe to purge the second end of the inner pipe of exhaust gases.

6. The mounting system of claim 1, wherein the first exhaust sampling port is located on a trailing edge of the outer pipe.

7. The mounting system of claim 1, further comprising:
a first protective housing disposed proximate the first end or the second end of the outer pipe;
wherein the protective housing is positively pressurized with an inert gas to minimize contaminant infiltration into the protective housing.

8. The mounting system of claim 1, the outer pipe further comprising:
an airfoil, disposed on the leading edge of the outer pipe to direct particles in an exhaust flow around the outer pipe.

9. A laser off gas analysis system for use in metallurgical furnaces comprising:
an outer pipe with a first end and a second end;
an inner pipe, with a first end and a second end, disposed coaxially within the outer pipe;
a first exhaust sampling port, disposed on the outer pipe and in fluid communication with the inner pipe, for receiving a gas sample from an exhaust flow;
a laser, coupled to the first end of the inner pipe, the outer pipe, or both, for generating a laser beam through the exhaust flow;
a laser receiver, coupled to the second end of the of the inner pipe, the outer pipe, or both, for receiving the laser beam from the laser after it has passed through the exhaust flow;
a first protective housing, disposed proximate the first end of the outer pipe, for enclosing the laser; and
a second protective housing, disposed proximate the second end of the outer pipe, for enclosing the laser receiver.

10. The laser off gas analysis system of claim 9, wherein the first exhaust sampling port is located on the trailing edge of the outer pipe to reduce the amount of particulate matter from the exhaust flow that enters the sampling area.

11. The laser off gas analysis system of claim 9, further comprising:
a second exhaust sampling port, disposed on the trailing edge of the outer pipe and in fluid communication with the inner pipe.

12. The laser off gas analysis system of claim 9, further comprising:
a second exhaust sampling port, disposed on the leading edge of the outer pipe and in fluid communication with the inner pipe.

13. A method for installing an off gas analysis system on an exhaust duct of a metallurgical furnace comprising:
inserting an alignment pipe, comprising a first end and a second end, through holes in the exhaust duct;
detachably coupling a sender to the first end of the alignment pipe;
detachably coupling a receiver to the second end of the alignment pipe;
detachably coupling a first protective housing proximate the first end of the alignment pipe such that it substantially encloses the sender; and
detachably coupling a second protective housing proximate second end of the alignment pipe such that it substantially encloses the receiver;
wherein the alignment pipe substantially maintains the alignment between the sender and the receiver; and
wherein the alignment pipe further comprises an exhaust sampling port disposed in the middle of the alignment pipe.

14. The method of claim 13, further comprising:
attaching a coolant supply to a coolant supply fitting on the alignment pipe; and
attaching a coolant return to a coolant return fitting on the alignment pipe;
wherein coolant flows into the coolant supply fitting and out of the coolant return fitting to cool the alignment pipe.

15. The method of claim 13, further comprising
attaching an inert gas supply to a first gas fitting on the first end of the alignment pipe; and
attaching the inert gas supply to a second gas fitting on the second end of the alignment pipe;
wherein the inert gas enters the first end of the inner pipe and exits the exhaust sampling port;
wherein the inert gas enters the second end of the inner pipe and exits the exhaust sampling port; and
wherein the inert gas purges the first and second ends of the inner pipe of exhaust gases.

16. The method of claim 13, further comprising:
inserting a packing material between the outer pipe and the holes in the exhaust duct to seal around the outer pipe.

17. The method of claim 13, further comprising:
attaching one or more mounting collars to the exhaust duct proximate the holes to reinforce the holes, seal around the alignment pipe, or both.

18. The method of claim 17, wherein the mounting collars are two piece mounting collars to ease installation and removal of the system.

19. The method of claim 13, further comprising:
attaching a coolant supply to a coolant supply fitting on the first protective housing; and
attaching a coolant return to a coolant return fitting on the first protective housing;
wherein coolant flows into the coolant supply fitting and out of the coolant return fitting to cool the first protective housing.

20. The method of claim 13, further comprising:
attaching an inert gas supply to a gas fitting on the first protective housing;
wherein the inert gas creates a pressurized, inert atmosphere inside the first protective housing.
